(19) United States
(12) Patent Application Publication
(10) Pub. No.: US 2019/0153347 A1
(43) Pub. Date: May 23, 2019

(54) METHOD TO REDUCE BUILD-UPS, CRUSTS AND RING FORMATION IN CLINKER PRODUCTION

(71) Applicant: Cemex Research Group AG, Brugg Bei Biel (CH)

(72) Inventors: Néstor Isaías QUINTERO MORA, Biel (CH); Lila Alexandra LOPEZ MIRANDA, Monterrey, Nuevo Leon (MX); Homero RAMIREZ TOVIAS, Monterrey, Nuevo Leon (MX)

(21) Appl. No.: 16/314,376

(22) PCT Filed: Jun. 29, 2016
(86) PCT No.: PCT/IB2016/053891

§ 371 Date: Dec. 28, 2018

(51) Int. Cl. C10L 10/04; C04B 7/44; C10L 5/32; C10L 10/02

(52) U.S. Cl. CPC C10L 10/04; C04B 7/4407; C04B 7/4492; C10L 5/32; C10L 2290/24; C10L 2200/0213; C10L 2250/06; C10L 2290/141; C10L 10/02

(57) ABSTRACT

Some embodiments are directed to a method to avoid the negative effect of both sulphur and vanadium presence contained in solid fuel used in cement clinker manufacturing line (build-up, kiln rings, etc.). Some embodiments are methods to prepare, dose and use a fuel additive based on an alkaline earth metal to allow the combination of vanadium and sulphur with said added alkaline earth metal, so that corrosion, build-up, crusts and ring formation in cement pre-heaters and kilns due to the presence of those components are avoided.

### CROSS REFERENCE TO RELATED APPLICATION(S)

This application is a National Phase Filing under 35 C.F.R. § 371 of and claims priority to PCT Patent Application No. PCT/IB2016/053891, filed on Jun. 29, 2016, the content of which is hereby incorporated in its entirety by reference.

### BACKGROUND

The presently disclosed subject matter relates to a method to avoid the negative effect of both sulphur and vanadium presence contained in solid fuel used in cement clinker manufacturing line (build-up, kiln rings, etc.). The presently disclosed subject matter is a method to prepare, dose and use a fuel additive based on an alkaline earth metal to allow the combination of vanadium and sulphur with said added alkaline earth metal, so that corrosion, build-up, crusts and ring formation in cement pre-heaters and kilns due to the presence of those components are avoided.

Concrete is the most widely used building material in the world. Cement, being the main component of concrete, plays a crucial role in the economic development of today's world and it is used in all types of constructions: residential, commercial and infrastructures. Therefore, it is easily understood that a high activity in the construction sector translates into a high cement demand and consequently, into an increase in cement production.

To meet the market demand, cement companies need to ensure continuous, economic and high quality cement production.

The main step in the cement production process includes heat treating a mixture of materials (limestone, clay, iron ore, among others) called raw meal. Some of the important elements in this mixture are silicon, aluminium, iron and calcium but also minor quantities of other substances are present, such as sulphur, magnesium, sodium, potassium, etc. The raw meal preparation includes firstly the steps of drying, crushing and grinding. Then, the raw meal is fed into the pre-heater, where it is gradually heated up from approximately 200° C. to 900° C. in order for the conversion of CaCO₃ present in the raw meal into CaO and CO₂ to take place. Subsequently, the calcined material (hot meal) enters into the kiln and is heated up from 900° C. to 1500° C., taking place the sintering phase. This is a crucial step to produce the main component of cement: clinker. The clinker contains minerals that are responsible for the unique properties of cement, said minerals being tricalcium silicate (Ca₃SiO₃, elite), dicalcium silicate (Ca₂SiO₄, belite), tricalcium aluminate (Ca₃Al₂O₆) and tetra-calcium aluminoferrite (4CaO.Al₂O₃Fe₂O₃).

In order to reach the high temperatures aforementioned, high amounts of energy are needed. This energy is derived from the combustion of fossil fuels, with coal and natural gas being the most common. Currently, the availability of these fuels is low and their cost is high, which has led the cement industry to seek cheaper alternatives and adapt the production process to make their use possible.

One of the lowest-cost fuel which has now became the main fuel used by the cement industry is petcoke, which normally contains between 4.5% and 8% of elemental sulphur. The fuel plays one of the important roles in the combustion process, since it generates the necessary heat to maintain the operational temperature. But when the fuel that contains sulphur is burned, the sulphur is oxidized to SO₂, which adds to the SO₂ coming from the raw materials. Consequently, the total amount of sulphur becomes significant, causing blockages in the pre-heater and kiln due to build-up, crusts and ring formation. This is a serious problem in the daily operation of cement plants, since when build-up, crusts and ring formation occur, the production process has to be stopped to allow the equipment to be cleaned.

The phenomenon of build-up, crusts and ring formation occur when the sulphur present in both fuels and raw materials comes into direct contact with the alkalis present in the raw materials, namely sodium and potassium, forming alkaline sulphates (Na₂SO₄ and K₂SO₄) which have high adhesion to the pre-heater and kiln surfaces, promoting an accumulation of overlapped deposits of these substances, forming the so called “build-up, crusts” or “ring” of material on the equipment's' walls. The presence of these formations causes problems in the operation by reducing the available area for heat transference. In critical cases, blockages in the pre-heater and rings formed in the kiln can lead to operational stoppages.

Prevention of build-up, crusts and sulphur-based rings formation is currently done by carrying out cleaning routines by the personnel using high pressure equipment to break down the obstruction. This means that the clinker manufacturing equipment has to be stopped in order to allow the cleaning process to take place, which of course means that the clinker production process has to be stopped, translating into high costs for the operations.

If vanadium is also present in the fuel used, then it will increase the formation rate of SO₃ and sulphated compounds, thus increasing the formation of build-ups and rings in the kiln and pre-heater.

Furthermore, during the calcination and sintering phases, if vanadium is present in the fuel, vanadium pentoxide forms which then reacts with sodium present in the raw meal to form vanadates of various composition ratios. Vanadates with composition Na₂O.6 V₂O₅ have a high corrosion rate at temperatures between 593° C. and 816° C., while at temperatures above to 816° C. other vanadates with higher proportion of vanadium occur, providing higher corrosion rates.

Na₂O.6V₂O₅↔Na₂O.V₂O₄.5V₂O₅+½O₂ (eq. 1)

Therefore, a method that simultaneously mitigates sulphur and vanadium present in the fuel should be ideal to prevent any negative effect in the cement clinker manufacturing line.

In the related art, several processes for the control of sulphur through the incorporation of additives, mainly based on magnesium oxide, are disclosed for different combustion systems, but most of them are applied to systems other than cement production and significantly differ from the presently disclosed subject matter.

MX2013009754 discloses an automated system for dosing an additive based on MgO that can be applied to the cement production process to eliminate or reduce scales and rings in rotary kilns and boilers. The solution provided is to incorporate an additive fed with the fuel but as an automated system for the storage and application of additives controlled by a software is disclosed. There is no information provided related to the formulation, dosage amounts, measurement of the efficiency of the method to control build-up, crusts and/or ring formations, etc. The main focus of the application is the description of the components of the automated system, its features and benefits of its use to control the addition of additive. It does not teach about the effect of MgO in the SO₂ cycle and its effects on clinker manufacturing processes.

US2014014010 discloses a method to reduce slag, which may also lead to ring formation, in the coal calcination process by using a two-components additive: the first component is selected from a series of magnesium containing components and the second ingredient is selected from acetates or nitrates of aluminium or copper, aluminium oxide or hydroxide and ammonium phosphate. Both ingredients may be added directly into the furnace or boiler or added to the coal as received prior to conveyance of the coal into the furnace or boiler. The dosage of the additive is based on the content of coal ash, therefore prior knowledge of this parameter is needed.

U.S. Pat. No. 7,276,217 describes a process by which a magnesium carbonate ore is calcined together with coal in order to capture toxic metals and reduce the formation of sulfuric acid that is generated during coal combustion. The difference between this disclosure and the other related art is that the ore is added to the coal prior to combustion and then, the magnesite-coal blend is after pulverized and fired, originating very fine particles with a significant particle surface area. To apply this disclosure in real case applications, one needs to have a source of magnesium carbonate ore available. This presents the obvious disadvantage that space needs to be allocated near the solid fuel for the magnesium ore, which may not be available in some plants.

US20150107498 establishes a system to optimize the efficiency of the boiler by reducing SO₃ through the injection of magnesium oxide. A method is proposed to find the dosage and the optimum zone to incorporate the magnesium oxide through measurements of SO₃ concentration at different points in the system, monitoring the boiler efficiency and the properties of the generated steam. Emphasis is placed on the role of Vanadium (in coal) as a catalyst for the conversion of SO₂ to SO₃, as well as the corrosion problems that are caused by said vanadium. The in-fuel/in-combustor feed rate, the mid and low-temperature feed rate and the total amount of magnesium oxide to be fed are left open to experimentation, therefore being dependent on the process. Since it is practically unfeasible to perform experimentation every time one wants to start the clinker production process, this method is extremely difficult to be put in place by the industry. Furthermore, US20150107498 focuses on low temperature systems that are not subject to a gas recirculation mechanism as in the case of the clinker production process, or contact with other compounds as in the case of the raw meal clinker.

WO2004026996 discloses a fuel additive for the reduction/removal of vanadium-containing ash deposits mainly in gas turbines. The additive includes a compound of a metal capable of forming a vanadate with vanadium dispersed in an oil soluble liquid. The metal compound should have a particle size distribution in the range of 0.1 to 2 micron, which complicates its implementation by the industry. WO2004026996 thus targets the removal of ash deposits in gas turbines. Also, the disclosure discloses that the vanadate deposit formed is “much easier to remove than the vanadate deposit formed when using related art compositions”, meaning that a vanadate deposit is still formed that needs to be cleaned, even if this is to a lesser extent. Moreover, WO2004026996 is bound to disperse the metal particles in an oil soluble liquid, which may be chosen from mineral oils, aromatic naphtha, diesel fuel or vegetable or animal oils. This means that additional oils need to be purchased to practice the disclosure, which not only increases the cost of the overall solution but also presents an environmentally unsustainable solution, since said oil will be burned in the process representing an additional CO₂ source. Finally, no mention to sulphur is made.

U.S. Pat. No. 4,412,844 discloses an aqueous dispersion for liquid hydrocarbon fuels made of magnesium hydroxide, water, a water-dispersible, oil-soluble, water-in-oil emulsifying agent having an HLB value of from 4-10 and a water-soluble, oil-dispersible emulsifying agent having an HLB of from 20-40. The second emulsifying agent is needed in order to ensure the stability of the slurry for 4 months. The method presented by U.S. Pat. No. 4,412,844 is limited to the usage of magnesium hydroxide and needs two emulsifying agents to be stable and to perform. Furthermore, the dispersion disclosed in the application is limited to liquid hydrocarbon fuels.

U.S. Pat. No. 4,783,197 describes a method of capturing sulphur released from burning carbonaceous fuels by providing an aqueous carbonaceous fuel composition slurry consisting of 60-80% by weight of carbonaceous fuel particles with an ash content of below about 5% by weight, 0.05-2.0% by weight of a non-ionic dispersant and water, to which a sulphur capturing substance, selected from hydroxides, oxides, and carbonates of calcium, magnesium, and manganese, and having a particle size below 10 microns is mixed. This assures that the sulphur is bound in the slurry as solid sulphide before it is converted into sulphur oxides during combustion. The method provided by U.S. Pat. No. 4,783,197 needs to ensure a fuel with a 5% maximum of ash content in order to avoid slag formation problems which means that, unless the fuel is pure coal, the fuel needs to be purified before it can be used. Additionally, according to U.S. Pat. No. 4,783,197, the fuel needs to be pre-treated and then mixed with the remaining components of the disclosed slurry. No mention to vanadium is done.

The related art fails to reveal a method which is simultaneously easy to adopt by the industry and efficient to completely avoid corrosion, build-up, crusts and ring formation in cement pre-heaters and kilns when sulphur and eventually vanadium is/are present in fuels. While some related art disclosed the use of fuel additives, however a poor dispersion of fuel additives into the fuels remains a common problem found in the prior-art, which translates into a poor removal of sulphur and/or vanadium from the fuels, meaning that build-up, crusts and ring formation still occur.

### SUMMARY

The inventors have now found a novel method to combine simultaneously sulphur and vanadium contained in solid carbonaceous fuels used in the clinker production process with an alkaline earth metal added to said fuel in order to avoid build-up, crusts, ring formation or corrosion in pre-heaters and/or kilns. Solid carbonaceous fuels are fuels that are stripped or mined from earth, such as coal, or are a by-product of oil refinement, such as petcoke. The novel method is to prepare, dose and use a fuel additive based on an alkaline earth metal to capture both vanadium and sulphur that are present in the solid fuels used in clinker manufacturing. It is to be noted that said fuel additive must or should be sufficiently reactive to work in the claimed method; that would not be the case for example of magnesium carbonate ore used in related art U.S. Pat. No. 7,276,217.

Another novel aspect is a fuel additive which is water-based. Indeed it is not desirable to inject water into the combustion process since the water will reduce kiln capacity. Accordingly the method here disclosed describes a fuel additive which is water based and can be used without reducing the kiln capacity, due to the unique method of usage that is also disclosed below.

Moreover it is to be noted that contrary to related art, for example US 2014014010 which discloses the use of a two-components additive to reduce ring formation in a coal calcination process, just one component is needed in the present fuel additive to efficiently eliminate ring formation in the kiln. Furthermore the dosage of said one-component additive of the presently disclosed subject matter does not depend on the amount of coal ash as in US 2014014010 but on the amount of vanadium content in the fuel, which can be easily determined through Flame Atomic Absorption Spectrometry or Inductively Coupled Plasma (ICP) Atomic Emission Spectrometry. An advantage of the present fuel additive is that the metal used therein may have a particle size distribution significantly higher than 0.1-2 microns, contrary to the range used for example in WO 2004026996; which greatly simplifies its implementation by the industry. Another advantage of the present fuel additive is that it is suitable for any type of carbonaceous fuel with any ash content and that no pretreatment is needed, contrary for example to related art U.S. Pat. No. 4,783,197 or related art U.S. Pat. No. 4,412,844.

The presently disclosed subject matter thus presents a unique and efficient method of simultaneously capturing sulphur and vanadium contained in solid fuels used in clinker production by combining simultaneously sulphur and vanadium (in vapor phase) with added alkaline earth metal in order to completely avoid build-up, crusts, ring formation or corrosion in pre-heaters and/or kilns, the method including formulating a fuel additive composition based on alkali earth metals and to use it. Said additive may be produced, stored and posteriorly used when solid carbonaceous fuels are burned.

Thus, the presently disclosed subject matter provides a method of simultaneously capturing sulphur and vanadium from solid carbonaceous fuels (used in the clinker production process) with an alkaline earth metal added to said fuel in order to avoid build-up, crusts, ring formation or corrosion in pre-heaters and/or kilns, wherein the solid carbonaceous fuels contain from 4.5% to 8% in weight of elemental sulphur and from 500 ppm to 5000 ppm of vanadium, the method including the steps of preparing a fuel additive composition, said fuel additive composition including
20%-60% (w/w) of solid active content of an oxide or hydroxide of an alkaline earth metal, 0.5%-5% (w/w) of solid active content of a suspension stabilizer, 35%-79.5% (w/w) of a water miscible liquid, dosing the fuel additive prepared in the preparing step according to the formula: Additive Dosage (ml/min)=V₂O₅ (ppm)×Fuel Supply (ton/min)×A. Wherein V₂O₅ (ppm) is the amount of V₂O₅ in ppm that is formed considering that the elemental vanadium present in the fuel react with oxygen to form V₂O₅, A is a factor ranging from 1.0 to 4.0, add the fuel additive to the solid carbonaceous fuel, grind the fuel additive together with the solid carbonaceous fuel, and feed the mixture fuel-fuel additive into the preheater and/or kiln, according to the needs of the clinker manufacturing process.

Another aspect of the presently disclosed is to provide a method to reduce build-up, crusts, ring formation or corrosion in pre-heaters and/or kilns, the method including combusting in the pre-heaters and/or kilns solid carbonaceous fuels containing from 4.5% to 8% in weight of elemental sulphur and from 500 ppm to 5000 ppm of vanadium in the presence of a fuel additive composition in amounts effective to reduce build-up, crusts, ring formation or corrosion, wherein said fuel additive composition including 20%-60% (w/w) of solid active content of an oxide or hydroxide of an alkaline earth metal; 0.5%-5% (w/w) of solid active content of a suspension stabilizer; and 35%-79.5% (w/w) of a water miscible liquid; is dosed according to the formula:

Additive Dosage (ml/min)=V₂O₅ (ppm)×Fuel Supply (ton/min)×A,

wherein V₂O₅ (ppm) is the amount of V₂O₅ in ppm that is formed considering that the elemental vanadium present in the fuel react with oxygen to form V₂O₅, and A is a factor ranging from 1.0 to 4.0; is added to the solid carbonaceous fuel; then the mixture fuel-fuel additive is fed into the preheater and/or kiln.

Following the steps described above, a water-based fuel additive can be produced and stored, having a shelf-life of about 1 year, or dosed according to the method disclosed above, added to the solid carbonaceous fuel, either in the conveyor belt that connects the solid carbonaceous fuel silo to the solid carbonaceous fuel mill or directly in the solid carbonaceous fuel mill, and grinded with the solid carbonaceous fuel in said mill. It provides a safe and economic alternative to reduce vanadium and sulphur present in the solid carbonaceous fuels, which will avoid corrosion problems, as well as build-up, crusts formation in the pre-heater and ring formation in the kiln, consequently avoiding production stoppages and subsequently production losses. Furthermore, according to the method herein disclosed, scrubbers and fluidized beds for the removal of SOx are avoided.

The fuel mill pulverizes the solid carbonaceous fuel before it is burned to increase the temperature of the pre-heater, kiln, pre-calciner and raw mill. So the fuel mill grounds suitable solid carbonaceous fuel and feeds it to the kiln and/or pre-heater in fluidized form. The solid carbonaceous fuel, after being obtained from mines or as by-product of other industries (for example, the petrochemical industry), is received at the plant and crushed at crusher site. Then it is sent to stacking and homogenised. When it is about to be used, the solid carbonaceous fuel is fed into the fuel mill hopper with the help of a belt conveyor. Then, it is fed into the fuel mill's vertical roller mill which is located just below the hopper. There, it is grounded between the roller and the table. Hot air, obtained from the cooler electrostatic precipitators fan, is taken inside the vertical roller mill and is used to dry the solid carbonaceous fuel. The fine solid carbonaceous fuel from the vertical roller mill is pulled by the induced draft (ID) fan into the cyclones, where most of the solid carbonaceous fuel is separated from air. The very small particles of solid carbonaceous fuel that are not collected (below 5 microns, mostly dust particles) are separated with the help of electrostatic precipitators. After grounded, the solid carbonaceous fuel is delivered to the storage bins and after, it is transported to the kiln and/or pre-calciner and/or pre-heater with the help of pumps.

The fuel mill is part of the clinker production process—it grinds large size particles, sometimes as big as 600 mm or more, into fine particles down to the size of 75-90 microns. This reduction in size allows a better burning of the solid carbonaceous fuel, obviously increasing the efficiency of the burning process.

If the additive would be fed in powder form directly into the fuel mill, the particles would be immediately drawn by the ID fan into the electrostatic precipitators and would not be mixed with the solid carbonaceous fuel. The mixing of the solid particles in water before the milling process allows the fuel additive particles to be dispersed on the solid carbonaceous fuel particles and grinded together.

It was found that having at from 4.5% to 8% in weight of elemental sulphur and simultaneously from 500 ppm to 5000 ppm of vanadium in the carbonaceous fuels helps in the removal of both components. Above 8% of sulphur and 5000 ppm of vanadium the method may be ineffective, since for such quantities of sulphur and vanadium, one will need more than 60% of alkaline earth metal in the preparing step, but when an amount above 60% of alkaline earth metal is used, said metal precipitates in the suspension, said suspension not being stable anymore.

In presence of oxygen, the following reaction occur:

4V+5O₂→2V₂O₅ (eq. 2)

V₂O₅ melts at relatively low temperature (600° C.-680° C.) and reacts with the sodium from the raw meal forming sodium salts such as sodium meta vanadate (NaVO₃) (melting point −630° C.). Vanadic corrosion is extremely fast, melted V₂O₅ forms a molten layer on metals and causing accelerated corrosion. Sodium and sulphur may react with the vanadium forming other components with reduced melting point, further accelerating corrosion.

The vanadium pentoxide reacts with sulphur dioxide coming from the fuel to produce sulphur trioxide:

SO₂+V₂O₅→SO₃+2 VO₂ (eq. 3)

Sodium in fuel is mainly present as NaCl and is quickly vaporized during combustion with many mechanisms possibly taking place during the process. At the end of the vaporization process, most of the sodium exists in the vapour phase either as NaCl or NaOH:

H₂O+NaCl↔NaOH+HCl (eq. 4)

The SO₃ present in the fuel gases will react with NaOH to form Na₂SO₄:

2NaOH+SO₂↔Na₂SO₄+H₂O (eq. 5)

Na₂SO₄ creates a sticky layer on the walls of the equipment which promotes the deposition of other solid particles (mainly CaSO₄, formed when the calcium of the limestone reacts with SO₃) which will thicken said layer on the pre-heater and kiln walls, leading to build-up, crusts and ring formation, which usually have a hard consistency and need to be manually removed, translating into production losses.

The vanadium will react with the formed sodium sulphate of equation 5 to form several types of sodium vanadates at different ratios:

Na₂SO₄+yV₂O₅↔Na₂O.yV₂O₅+SO₃ (y=1,3 or 6) (eq. 6)

The sodium vanadates formed through equation 6 are extremely corrosive and may dissociate further, react with sulphur dioxide to form sulphur trioxide and also combine with iron:

Na₂O.6V₂O₅↔Na₂O.V₂O₄.5V₂O₅+½O₂ (eq. 7)

Na₂O.6V₂O₅+SO₂↔Na₂O.V₂O₄.5V₂O₅+SO₃ (eq. 8)

Na₂O.V₂O₅+Fe↔Na₂O.V₂O₄.5V₂O₅+FeO (eq. 9)

TABLE 1
Melting point of some of the compounds formed

| Compound | Melting point (° C.) |
|---|---|
| V₂O₅ | 600-680 |
| Na₂SO₄ | 887 |
| Na₂O•V₂O₅ | 682 |
| Na₂O•V₂O₄•5V₂O₅ | 535 |

Another embodiment is the method of the presently disclosed subject matter, wherein the alkaline earth metal used is magnesium, because of its affinity to both vanadium and sulphur, high availability (magnesium is naturally found in sea water and brines) and it is a safe compound to handle. Both magnesium oxide and magnesium hydroxide are suitable according to the presently disclosed subject matter.

When in the oxide form, magnesium will react with both Sulphur and vanadium according to the following equations:

MgO+SO₃→MgSO₄ (eq. 10)

3MgO+V₂O₅→Mg₃(VO₄)₂ (eq. 11)

While magnesium hydroxide will react with sulphur and vanadium according to the equations:

Mg(OH)₂+SO₂→MgSO₄+H₂O (eq. 12)

3Mg(OH)₂+V₂O₅→Mg₃(VO₄)₂+3H₂O (eq. 13)

The magnesium compounds formed by equations 10-13 are stable and will become part of the clinker composition. The properties of the clinker formed is not negatively affected.

In order to assure a proper distribution of the alkali earth metal into the fuel and also to assure that its reactivity with both sulphur and vanadium is high, the alkaline earth metal that is added in the preparing step should have a particle size below 20 microns to be sufficiently reactive. Using an alkaline earth metal with a higher particle size would not work, since it would not be reactive enough. Also, the grinding step is to ensure that the fuel additive is mixed with the solid carbonaceous fuel and not to further grind the alkaline earth metal. In fact, the solid carbonaceous mill has an efficiency of 90% passing 75 microns, therefore such a small particle size as 20 microns would not be obtained merely by grinding the metal in the solid carbonaceous fuel mill. Therefore, the alkaline earth metal should have already a particle size below 20 microns when is handled in the preparing step.

Therefore, another embodiment is the method of the presently disclosed subject matter, wherein the alkaline earth metal in the preparing step has a particle size between 2 and 20 microns, and in some embodiments between 8 and 12 microns.

Another embodiment is the method of the presently disclosed subject matter, wherein the alkaline earth metal is reactive magnesia, also called caustic calcined magnesia. Reactive magnesia, also called caustic calcined magnesia, is produced at temperatures between 600° C. and 1000° C., whereas normal magnesia is produced at temperatures between 1500° C. and 2000° C. The lower production temperatures of reactive magnesia render this product, as the name says, a higher reactivity when compared to normal magnesia, which makes it suitable to be part of chemical reactions, while normal magnesia is more suitable to be used in the manufacturing of refractory products. Furthermore, since the particle size needs to be inferior to 20 microns, a higher reactivity is achieved. In fact, it was observed that normal magnesia, produced at temperatures between 1500° C. and 2000° C. does not hydrate in the presence of water and simply precipitates when mixed with water or water miscible liquid. Reactive magnesia, on the other hand, hydrates very well in water or water miscible liquid, providing a fuel additive that, together with the stabilizer used, is stable and simultaneously reactive with the sulphur and vanadium present in the solid carbonaceous fuel.

Thus, in order to ensure the dispersion of the particles in the liquid and stability of the suspension and guarantee a shelf-life of about 1 year, a stabilizer is added in the dosing step. The stabilizer is a key element of the formulation—not only it ensures the dispersion of the particles in the medium and the stability of the final additive, it also assures a perfect interaction between fuel and alkali earth metal during the grinding step, which is essential for the reaction between the alkali earth metal particles and the sulphur/vanadium present in the fuel. Contrarily to the related art, the good dispersion of the particles due to this formulation and the good interaction between fuel and metal guarantee that no corrosion is observed and no build-up, crusts as well as rings are formed.

So, another embodiment according to the presently disclosed subject matter is the method wherein the suspension stabilizer is selected from the group consisting of Tributyl phosphate (TBP), Triethylamine (TEA), silicone-based surfactants, Cetyl trimethyl ammonium chloride, Cetyl Trimethyl Ammonium Bromine, butoxy polypropylene glycol, Lauryl betaine, Triisobutyl Phosphate (TIBP), Polyethylene glycol (PEG), Sodium dodecyl sulfate, Sodium alpha olefin sulfonate, Sodium Alkane Sulfonate or mixtures thereof.

Both the alkali earth metal oxide or hydroxide and the stabilizer are mixed in a water miscible liquid medium. The liquid medium ensures proper integration of the other two components with the fuel. The alkali earth metal cannot be introduced in solid form into the process because it will be sucked by the ID fan. Therefore, both alkali earth metal and stabilizer are mixed in the liquid medium which will evaporate during the grinding step between fuel additive and fuel (the temperature in the solid carbonaceous mill is around 100° C.). Hence, no extra water is added into the system. When the additive components reach the pre-heater and/or the kiln, the particles are already perfectly dispersed within the fuel. The water does not harm the system since the water is evaporated in the fuel mill.

Thus, another embodiment according to the presently disclosed subject matter is the method wherein the water soluble liquid is selected from water, methanol, ethanol, propanol, butanol, acetone or mixtures thereof.

The fuel additive may be used immediately after being formulated or it can be stored and posteriorly used. In any case, to ensure the proper dispersion of the components, it is may be necessary to agitate the mix before usage (feeding step)). A normal stirring during 5 minutes suffices.

Another embodiment according to the presently disclosed subject matter is the method wherein the fuel additive, after being prepared according to the preparing step, is stored for further use.

The amount of additive that should be dosed is given by a formula relating the amount of vanadium in the fuel (which is produced according to equation 2) in ppm, the fuel supply (in ton/min) and a factor:

Additive Dosage (ml/min)=V₂O₅ (ppm)×Fuel Supply (ton/min)×A (eq. 14)

Factor A is between 1.0 and 4.0.

Wherein V₂O₅ (ppm) is the amount of V₂O₅ in ppm that is formed considering that the elemental vanadium present in the fuel react with oxygen to form V₂O₅ according to equation 2.

To determine the amount of V₂O₅ that is formed considering that the elemental vanadium present in the fuel reacts with oxygen to form V₂O₅ according to equation 2, one needs first to measure the amount of elemental vanadium present in the fuel, which is done through Inductively Coupled Plasma (ICP) Atomic Emission Spectroscopy, according to the norm ASTM D5708 or through Flame Atomic Absorption Spectrometry, according to the norm ASTM D5863. Knowing that the molar mass of vanadium is 50.94 g/mol and V₂O₅ is 181.88 g/mol, the total amount if V₂O₅ produced according equation 2 can be calculated.

The equation 14 gives back the amount in ml/min of fuel additive one should add to the solid carbonaceous fuel before grinding knowing the flow of fuel that is feed to the mill, in ton/min. Obviously, the total amount of fuel additive, in ml, for the whole process may also be calculated if one knows the total amount of solid carbonaceous fuel, in tons, that will enter into the process:

Additive Dosage (ml)=V₂O₅ (ppm)×Fuel Amount (ton)×A (eq. 15)

The additive dosage formula is based on the amount of V₂O₅ because the clinker production process is done under normal oxidizing conditions, so the vanadium present in the fuel will be converted to V₂O₅ according to equation 2.

The factor A being between 1.0 and 4.0, is dependent on the density of the fuel additive:

Factor A=0.957/(0.5×ρ_{additive}) (eq. 16)

where the additive density is given in g/ml.

The feeding process of the additive into the solid carbonaceous fuel mill can be controlled by a dosing system which includes a recirculation pump or stirrer, a peristaltic pump, a flow regulator and suitable tubing for carrying the additive from the storage containers into the solid carbonaceous fuel feed (FIG. 1), but other feeding methods may be suitable.

Another embodiment according to the presently disclosed subject matter is the method wherein in the adding step, the fuel additive is added to the solid carbonaceous fuel in the solid carbonaceous fuel conveyor belt.

Another embodiment according to the presently disclosed subject matter is the method wherein in the adding step the fuel additive is sprayed onto the solid carbonaceous fuel in the belt conveyor.

Another embodiment according to the presently disclosed subject matter is the method wherein in the adding step, the fuel additive is added to the solid carbonaceous fuel inside the solid carbonaceous fuel mill.

The presently disclosed subject matter presents several advantages:

The benefit of having a system with less crusting results in a more stable operation by keeping the preheater and kiln clean and without build-up, crusts. This translates into:
A lower frequency and time spent on cleaning
Low pressures in the combustion chamber and calciner
Temperature control
Low sulphur evaporation in the preheater

It can also represent economic benefits by impacting on the following parameters:
Increased performance
Lower energy consumption (Kcal/kg clinker)
Less equipment wear since high water pressure pumps are used less frequently to remove the crust formed.

Carbonaceous fuels. Fuels that are stripped or mined from earth, for example coal, petroleum, peat or fuel that are by-products of the oil refining process, such as petcoke.

Hydraulic binder. It is a material with cementing properties that sets and hardens due to hydration even under water. Hydraulic binders produce calcium silicate hydrates also known as CSH.

Clinker. Dark grey nodular material made by heating ground limestone and clay at a temperature of about 1400° C.-1500° C. The nodules are ground up to a fine powder to produce cement, with a small amount of gypsum added to control the setting properties.

Cement. It is a binder that sets and hardens and brings materials together. The most common cement is the ordinary Portland cement (OPC) and a series of Portland cements blended with other cementitious materials.

Ordinary Portland cement. Hydraulic cement made from grinding clinker with gypsum. Portland cement contains calcium silicate, calcium aluminate and calcium ferroaluminate phases. These mineral phases react with water to produce strength.

Hydration. It is the mechanism through which OPC or other inorganic materials react with water to develop strength. Calcium silicate hydrates are formed and other species like ettringite, monosulfate, Portlandite, etc.

Mineral Addition. Mineral admixture (including the following powders: silica fume, fly ash, slags) added to concrete to enhance fresh properties, compressive strength development and improve durability.

Silica fume. Source of amorphous silicon obtained as a byproduct of the silicon and ferrosilicon alloy production. Also known as microsilica.

Admixture. Chemical species used to modify or improve concrete's properties in fresh and hardened state. These could be air entrainers, water reducers, set retarders, superplasticizers and others.

Silicate. Generic name for a series of compounds with formula Na₂O.nSiO₂. Fluid reagent used as alkaline liquid when mixed with sodium hydroxide. Usually sodium silicate but can also include potassium and lithium silicates. The powder version of this reagent is known as metasilicates and could be pentahydrates or nonahydrates. Silicates are referred as Activator 2 in examples in this application.

Superplasticizers. It relates to a class of chemical admixture used in hydraulic cement compositions such as Portland cement concrete having the ability to highly reduce the water demand while maintaining a good dispersion of cement particles. In particular, superplasticizers avoid particle aggregation and improve the rheological properties and workability of cement and concrete at the different stage of the hydration reaction.

Coarse Aggregates. Manufactured, natural or recycled minerals with a particle size greater than 8 mm and a maximum size lower than 32 mm.

Fine Aggregates. Manufactured, natural or recycled minerals with a particle size greater than 4 mm and a maximum size lower than 8 mm.

Sand. Manufactured, natural or recycled minerals with a particle size lower than 4 mm.

Concrete Ingredients. Concrete is primarily a combination of hydraulic binder, sand, fine and/or coarse aggregates, water. Admixture can also be added to provide specific properties such as flow, lower water content, acceleration, etc.

Workability. The workability of a material is measured with a slump test (see below).

Workability retention. It is the capability of a mix to maintain its workability during the time. The total time depends on the application and the transportation.

Strength development—setting/hardening. The setting time starts when the construction material changes from plastic to rigid. In the rigid stage the material cannot be poured or moved anymore. After this phase the strength development corresponding to the hardening of the material.

Stabilizer. Chemical which inhibits the separation of suspensions, emulsions or foams.

Build-up, crusts and Ring Formation. When liquid material sticks to the walls of the pre-heater it creates a build-up, crusts. When the deposits are adhered to the kiln tube wall, they are called ring because of its shape around the kiln tube.

Solid Carbonaceous Fuel Mill. Also called Petcoke Mill or Coal Mill. Mill to produce pulverized petcoke or coal before burning, in order to increase the temperature of the process.

Reactive Magnesia. Also called Caustic calcined magnesia. Amorphous magnesia (MgO) with low lattice energy and is made at low temperatures (600° C.-1,000° C.) and finely ground.

Hot meal. Raw mill that has passed through the pre-heater and heated-up there to approximately 1000° C. The hot meal then exits the pre-heater and enters the kiln and travels towards the fusion zone, when it is heated to 1450° C. forming clinker.

### BRIEF DESCRIPTION OF THE FIGURES

FIG. 1. represents a possible fuel additive dosing system

FIG. 2. represents sulphur (SO₃) measurements before and after fuel additive is added. Process is running for 75 days without additive. At the 75^{th} day, fuel additive is added and process was continued with additive for another 105 days.

FIG. 3. represents pressure in the calciner and in the kiln, as well as the amount of O₂ available in the kiln. Process is running for 75 days without additive. At the 75^{th} day, fuel additive is added and process was continued with additive for another 105 days.

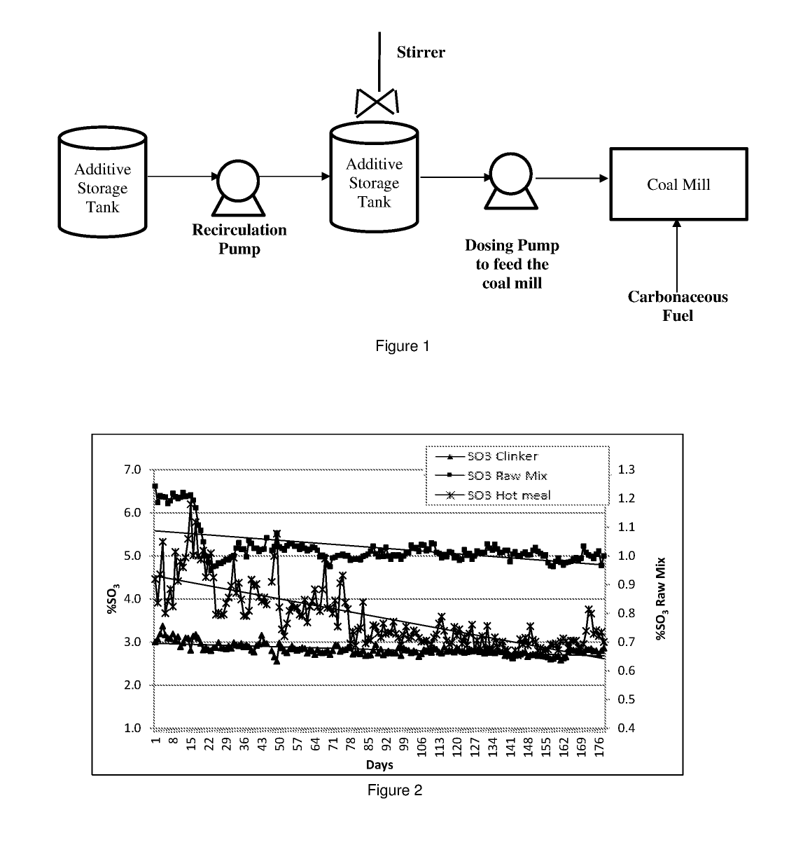

### DETAILED DESCRIPTION OF EXEMPLARY EMBODIMENTS

### Example 1

Clinker production was started using a fuel with the following characteristics:

| | |
|---|---|
| Fuel | Coke |
| V₂O₅ content | 840 ppm |
| Fuel supply into the fuel mill | 16 ton/h = 0.267 ton/min |

The clinker production was maintained during 75 days with no additive addition. After 75 days, additive was dosed and added into the fuel.

Additive dosage was calculated:

Additive Dosage (ml/min)=V₂O₅ (ppm)×Fuel Supply (ton/min)×A

Factor A=1.1

Additive Dosage (ml/min)=840×0.267×1.1=248 ml/min

Fuel additive was dosed and dispersed on top of the coke that was traveling on the conveyor belt into the fuel mill. Coke and additive were grinded together in the fuel mill. The treated, grounded coke was then fed into the kiln.

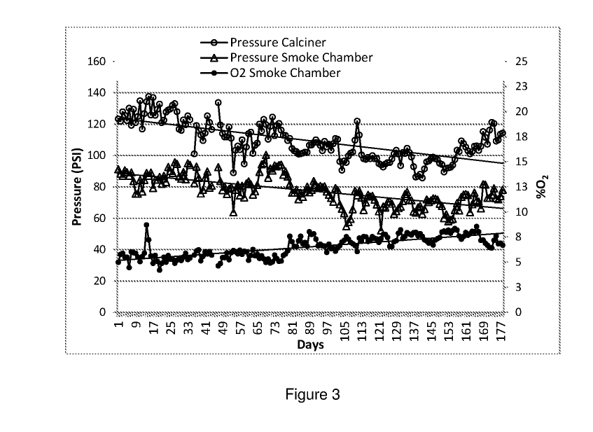

FIGS. 2-3 show the results before and after additive was added.

From FIG. 2, one can see that SO₃ in the raw mix has a significant decrease after the additive is added (75th day).

From FIG. 3, one can see a decrease in both pressures in calciner and smoke chamber, which is the chamber just below the calciner, as well as an increase in the amount of O₂ in the smoke chamber. This is easily justified since vanadium will no longer react with oxygen to produce V₂O₅ and more oxygen will be available.

### Example 2

Clinker was produced for 120 days without any fuel additive was used. Process parameters related to the raw mix, fuel (wherein the fuel used was petcoke), hot meal, kiln and clinker were regularly measured.

After 120 days, fuel additive was measured based on the amount of petcoke and added to the fuel in the fuel mill. During 120 days, fuel additive was constantly used together with the petcoke. The same process parameters related to raw mix, fuel, hot meal, kiln and clinker were regularly measured.

The average of the process parameters is summarized in Table 2.

TABLE 2
Process parameters before and after additive addition

| Process | Variable | Before | After |
|---|---|---|---|
| Kiln | Clinker prod. (tpd) | 1202 | 1287 |
| Kiln | Cleaning (h) | 8 | 2 |
| Kiln | O₂ Level (%) | 3.8 | 5.0 |
| Kiln | SO₃ Evaporation (%) | 53 | 43 |
| Kiln | Energy consumption (kcal/kg clk) | 996 | 929 |
| Kiln | Control Temperature (° C.) | 811 | 811 |
| Kiln | Calciner pressure (mbar) | 38 | 26 |
| Raw Mix | Lime Saturation Factor | 103 | 103 |
| Raw Mix | Silica Ratio | 2.86 | 2.81 |
| Raw Mix | SO₃ (%) | 1.0 | 1.0 |
| Hot meal | SO₃ (%) | 5.6 | 4.4 |
| Hot meal | Vanadium (V, ppm) | 1008 | 392 |
| Clinker | Lime Saturation Factor | 98 | 98 |
| Clinker | Silica Ratio | 2.85 | 2.8 |
| Clinker | SO₃ (%) | 3.1 | 3.1 |
| Clinker | Free lime (%) | 1.1 | 1.2 |
| Petcoke | Sulfur (% S) | 5.8 | 5.8 |
| Petcoke | Vanadium (ppm, V₂O₅) | 1450 | 1450 |
| Petcoke | Input (ton/min) | 0.27 | 0.27 |
| Additive | Dosage (ml/min) | 0 | 528 |

Before additive addition, the average daily clinker production was 1202 tons/day. After the additive was used, clinker produced increased to 1287 tons/day.

During 120 days, 8 hours were dedicated to cleaning before additive was used; with the additive, cleaning was reduced to approximately 2 hours. No build-ups nor ring formation were observed and cleaning was merely for maintenance.

The level of O₂ in the kiln improved from 3.8% (without additive) to 5.0% (with additive), which also improved burnability.

SO₃ evaporation was reduced from 53% (without additive) to 43% (with additive), since SO₃ was entrapped by the additive.

While the process temperature was maintained (811° C.), energy consumption was reduced from 996 kcal/kg (without additive) to 929 kcal/kg (with additive) due to the improved process efficiency.

The calciner pressure was reduced from 38 mbar (without the additive) to 26 mbar (with the additive), since no build-ups nor ring formations were observed. The additive didn't influence the raw mix properties.

It was observed that the additive also brought a beneficial impact in the vanadium present in the hot meal, which was reduced from 1008 ppm (without additive) to 392 ppm (with additive). Since the hot meal is heated up in the pre-heater with the hot gases that derive from the kiln, which in turn is heated up by the fuel burned, normally less vanadium will be present in said hot gases and therefore, less vanadium will appear in the hot meal analysis. The clinker properties were not affected by the additive usage.

Both SO₃ and vanadium levels are reduced with the additive usage.

### Example 3

In another plant, the same process monitoring was done as in Example 2. Clinker was produced for 120 days without any fuel additive was used. Process parameters related to the raw mix, fuel (wherein the fuel used was petcoke), hot meal, kiln and clinker were regularly measured.

After 120 days, fuel additive was measured based on the amount of petcoke and added to the fuel in the fuel mill. During 120 days, fuel additive was constantly used together with the petcoke. The same process parameters related to raw mix, fuel, hot meal, kiln and clinker were regularly measured.

The average of the process parameters is summarized in Table 3.

TABLE 3
Process parameters before and after additive addition.

| Process | Parameter | Before | After |
|---|---|---|---|
| Kiln | Clinker prod. (tpd) | 2717 | 2915 |
| Kiln | Cleaning (h) | 8 | 3 |
| Kiln | O₂ Level (%) | 5.4 | 6.8 |
| Kiln | SO₃ Evaporation (%) | 42 | 30 |
| Kiln | Energy consumption (kcal/kg clk) | 999 | 950 |
| Kiln | Control Temperature (° C.) | 916 | 890 |
| Kiln | Calciner pressure (mbar) | 49 | 44 |
| Raw Mix | Lime Saturation Factor | 103 | 103 |
| Raw Mix | Silica Ratio | 2.8 | 2.8 |
| Raw Mix | SO₃ (%) | 1.0 | 1.0 |
| Hot meal | SO₃ (%) | 5.8 | 4.6 |
| Hot meal | Vanadium(V, ppm) | 560 | 168 |
| Clinker | Lime Saturation Factor | 98 | 98 |
| Clinker | Silica Ratio | 2.9 | 2.9 |
| Clinker | SO₃ (%) | 3.3 | 3.3 |
| Clinker | Free lime (%) | 1.2 | 1.2 |
| Petcoke | Sulfur (% S) | 6.5 | 6.5 |
| Petcoke | Vanadium (ppm V₂O₅) | 950 | 950 |
| Petcoke | Input (ton/min) | 0.3 | 0.3 |
| Admixture | Dosage (ml/min) | 0 | 428 |

Before additive addition, the average daily clinker production was 2717 tons/day. After the additive was used, clinker produced increased to 2915 tons/day.

During 120 days, 8 hours were dedicated to cleaning before additive was used; with the additive, cleaning was reduced to approximately 3 hours. No build-ups nor ring formation were observed and cleaning was merely for maintenance.

The level of O₂ in the kiln improved from 5.4% (without additive) to 6.8% (with additive), which also improved burnability.

SO₃ evaporation was reduced from 42% (without additive) to 30% (with additive), since SO₃ was entrapped by the additive.

The process temperature was also reduced from 916° C. (without additive) to 890° C. (with additive), energy consumption was reduced from 999 kcal/kg (without additive) to 950 kcal/kg (with additive) due to the improved process efficiency.

The calciner pressure was reduced from 49 mbar (without the additive) to 44 mbar (with the additive), since no build-ups nor ring formations were observed. The additive didn't influence the raw mix properties.

It was observed that the additive also brought a beneficial impact in the vanadium present in the hot meal, which was reduced from 560 ppm (without additive) to 168 ppm (with additive). Since the hot meal is heated up in the pre-heater with the hot gases that derive from the kiln, which in turn is heated up by the fuel burned, normally less vanadium will be present in said hot gases and therefore, less vanadium will appear in the hot meal analysis.

The clinker properties were not affected by the additive usage.

Both SO₃ and vanadium levels are reduced with the additive usage.

### Example 4

In another plant, the same process monitoring was done as in Examples 2 and 3. This time, a petcoke with a lower content of vanadium was used to see the efficiency of the additive at lower levels.

Clinker was produced for 120 days without any fuel additive was used. Process parameters related to the raw mix, fuel (wherein the fuel used was petcoke), hot meal, kiln and clinker were regularly measured.

After 120 days, fuel additive was measured based on the amount of petcoke and added to the fuel in the fuel mill. During 120 days, fuel additive was constantly used together with the petcoke. The same process parameters related to raw mix, fuel, hot meal, kiln and clinker were regularly measured.

The average of the process parameters is summarized in Table 4.

TABLE 4
Process parameters before and after additive addition.

| Process | Parameter | Before | After |
|---|---|---|---|
| Kiln | Clinker prod. (tpd) | 2395 | 2521 |
| Kiln | Cleaning (h) | 6 | 2 |
| Kiln | O₂ Level (%) | 5.6 | 7.0 |
| Kiln | SO₃ Evaporation (%) | 27 | 15 |
| Kiln | Energy consumption (kcal/kg clk) | 914 | 900 |
| Kiln | Control Temperature (° C.) | 926 | 917 |
| Kiln | Calciner pressure (mbar) | 78 | 72 |
| Raw Mix | Lime Saturation Factor | 104 | 104 |
| Raw Mix | Silica Ratio | 2.85 | 2.85 |
| Raw Mix | SO₃ (%) | 1.1 | 1.1 |
| Hot meal | SO₃ (%) | 4.2 | 3.3 |
| Hot meal | Vanadium (ppm) | 280 | 56 |
| Clinker | Lime Saturation Factor | 99 | 99 |
| Clinker | Silica Ratio | 2.74 | 2.7 |
| Clinker | SO₃ (%) | 3.0 | 2.9 |
| Clinker | Free lime (%) | 1.57 | 1.56 |
| Petcoke | Sulfur (% S) | 4.7 | 4.7 |
| Petcoke | Vanadium (ppm V₂O₅) | 550 | 550 |
| Petcoke | Input (ton/min) | 0.3 | 0.3 |
| Admixture | Dosage (ml/min) | 0 | 198 |

Before additive addition, the average daily clinker production was 2395 tons/day. After the additive was used, clinker produced increased to 2521 tons/day.

During 120 days, 6 hours were dedicated to cleaning before additive was used; with the additive, cleaning was reduced to approximately 2 hours. No build-ups nor ring formation were observed and cleaning was merely for maintenance.

The level of O₂ in the kiln improved from 5.6% (without additive) to 7.0% (with additive), which also improved burnability.

SO₃ evaporation was reduced from 27% (without additive) to 15% (with additive), since SO₃ was entrapped by the additive.

The process temperature was also reduced from 926° C. (without additive) to 917° C. (with additive), energy consumption was reduced from 914 kcal/kg (without additive) to 900 kcal/kg (with additive) due to the improved process efficiency.

The calciner pressure was reduced from 78 mbar (without the additive) to 72 mbar (with the additive), since no build-ups nor ring formations were observed. The additive didn't influence the raw mix properties.

It was observed that the additive also brought a beneficial impact in the vanadium present in the hot meal, which was reduced from 280 ppm (without additive) to 56 ppm (with additive). Since the hot meal is heated up in the pre-heater with the hot gases that derive from the kiln, which in turn is heated up by the fuel burned, normally less vanadium will be present in said hot gases and therefore, less vanadium will appear in the hot meal analysis.

The clinker properties were not affected by the additive usage.

Both SO₃ and vanadium levels are reduced with the additive usage, which is also effective at the lower limit of vanadium content.

1. A method of simultaneously capturing sulphur and vanadium from solid carbonaceous fuels-, wherein the solid carbonaceous fuels contain from 4.5% to 8% in weight of elemental sulphur and from 500 ppm to 5000 ppm of vanadium, the method comprising:
preparing a fuel additive composition, the fuel additive composition including,
20%-60% (w/w) of solid active content of an oxide or hydroxide of an alkaline earth metal,
0.5%-5% (w/w) of solid active content of a suspension stabilizer, and
35%-79.5% (w/w) of a water miscible liquid;
dosing the fuel additive prepared in the preparing step according to the formula,
Additive Dosage (ml/min)=V₂O₅ (ppm)×Fuel Supply (ton/min)×A,
wherein V₂O₅ (ppm) is the amount of V₂O₅ in ppm that is formed considering that all the elemental vanadium present in the fuel react with oxygen to form V₂O₅, and
A is a factor ranging from 1.0 to 4.0;
adding the fuel additive to the solid carbonaceous fuel;
grinding the fuel additive together with the solid carbonaceous fuel; and
feeding the mixture fuel-fuel additive into the preheater and/or kiln, according to the needs of the clinker manufacturing process.

2. The method according to claim 1, wherein the solid active content of the alkaline earth metal used in the preparing step is between 40% and 50% (w/w).

3. The method according to claim 1, wherein the alkaline earth metal is magnesium.

4. The method according to claim 1, wherein the alkaline earth metal is reactive magnesia.

5. The method according to claim 1, wherein the alkaline earth metal has a particle size between 2 and 20 microns.

6. The method according to claim 1, wherein the suspension stabilizer used in the preparing step is selected from the group consisting of Tributyl phosphate (TBP), Triethylamine (TEA), silicone-based surfactants, Cetyl trimethyl ammonium chloride, Cetyl Trimethyl Ammonium Bromine, butoxy polypropylene glycol, Lauryl betaine, Triisobutyl Phosphate (TIBP), Polyethylene glycol (PEG), Sodium dodecyl sulfate, Sodium alpha olefin sulfonate, Sodium Alkane Sulfonate or mixtures thereof.

7. The method according to claim 1, wherein the water soluble liquid is selected from water, methanol, ethanol, propanol, butanol, acetone or mixtures thereof.

8. The method according to claim 1, wherein the fuel additive, after being prepared according to the preparing step is stored for further use.

9. The method according to claim 1, wherein in the adding step, the fuel additive is added to the solid carbonaceous fuel in the solid carbonaceous fuel conveyor belt.

10. The method according to claim 1, wherein in the adding step, the fuel additive is sprayed onto the solid carbonaceous fuel in the belt conveyor.

11. The method according to claim 1, wherein in the adding step, the fuel additive is added to the solid carbonaceous fuel inside the solid carbonaceous fuel mill.
